(19) United States
(12) Patent Application Publication
(10) Pub. No.: US 2026/0042066 A1
(43) Pub. Date: Feb. 12, 2026

(54) Direct-drive Electrodialysis Separation Using Flow-commanded Current Control

(71) Applicant: Massachusetts Institute of Technology, Cambridge, MA (US)

(72) Inventors: Jonathan Bessette, Cambridge, MA (US); Shane Pratt, Brookline, MA (US); Amos G. Winter, Carlisle, MA (US)

(21) Appl. No.: 19/099,548

(22) PCT Filed: Jul. 31, 2023
(86) PCT No.: PCT/US2023/029089

§ 371 Date: Jan. 29, 2025

Related U.S. Application Data
(60) Provisional application No. 63/397,514, filed on Aug. 12, 2022.

(51) Int. Cl. B01D 61/54; C02F 1/00; C02F 1/469

(52) U.S. Cl. CPC B01D 61/54; C02F 1/008; C02F 1/4693; B01D 2313/243; B01D 2313/367; B01D 2313/701; C02F 2201/009; C02F 2209/006; C02F 2209/40

(57) ABSTRACT

An electrodialysis system controller is configured to be coupled to a power supply, and powered devices that include a pump, and an electrodialysis unit. The controller receives inputs including an input indicative of a flow rate through the electrodialysis unit, an input indicative of a concentration level of fluid in the electrodialysis unit, and an input indicative of a power differential (e.g., indicating a degree to which a power usage by the powered devices differs from available power of the power source), and provides outputs for controlling the powered devices, including an output for causing a variable current level to be applied in the electrodialysis unit, and an output for causing a variable fluid flow rate through the electrodialysis unit. The controller is configured to match the power usage to the available power, for example, to keep the power differential as small as possible, while maximizing the theoretical desalination rate of the electrodialysis system.

### CROSS-REFERENCE TO RELATED APPLICATIONS

This is an International Application that claims be benefit of U.S. Provisional Application 63/397,514, filed on Aug. 12, 2022, which is incorporated herein by reference.

### BACKGROUND OF THE INVENTION

This invention relates to electrodialysis separation.

In many parts of the world, potable water is scarce. To meet a growing water demand for areas from drinking water and irrigation to power plants and other industrial processes, more and more groundwater is extracted. However, much of this groundwater is becoming increasingly saline with global climate change, including aridification and sea-level rise. Dependency on groundwater is highest in emerging economies. In arid and semi-arid regions, groundwater is usually the only source of water in spite of widespread salinization. Harnessing water, including saline groundwater is a grand challenge promoted by the U.S. Department of Energy.

Although desalination technologies are available, many desalination systems produce large quantities of brine, which is difficult to mitigate, particularly inland. Therefore, higher desalination recovery rates are desirable, to reduce brine production. Additionally, common desalination technologies require significant amounts of reliable, consistent energy. Remote, developing communities, and even large scale industries are attempting to integrate renewables for desalination, however, they are faced with high operating and capital expenditure, maintenance, and complexity due to reliance on energy storage such as batteries. Eliminating the need for batteries with renewable desalination could enable adoption in developing economies, and decarbonization in large-scale plants.

One current desalination technology is electrodialysis reversal (EDR) in which ions move across ion exchange membranes. When these ion exchange membranes are arranged in an alternating manner, channels of diluate and concentrate are formed between them. A production rate of desalinated water depends on the voltage applied to the membranes and a rate at which water flows through the channels. However, there are nontrivial constraints on the flow rate and voltage applied, which avoid water splitting. There additionally exists an optimal voltage and flow rate to maximize water production rate.

In general, EDR provides a higher recovery rate than reverse osmosis (RO), especially at small scales, such as in small village and individual dwelling settings. In addition, EDR is more energetically efficient at low salinity ranges, which are typical for groundwater. Thus, EDR is well suited for reducing the salinity of groundwater with less energy consumption and less brine production than RO. It additionally has applications for partial desalination of higher concentrations such as seawater, can be applied to make ultrapure water for semiconductors, power plants, and pharmaceuticals, or can ultraconcentrate water for brine mining and valorization.

Solar-powered photovoltaic panels and wind turbine electric generators provide logical power sources for EDR systems, particularly in resource-constrained regions, such as parts of India and Africa. However, wind varies, sometimes erratically. Similarly, solar irradiance at low latitudes on earth varies over the course of a day, generally following a bell curve, peaking around mid-day, and subject to irregular cloud cover.

A low cost, energy efficient desalination system that adapts to, and fully utilizes varying available power would be highly desirable. Accomplishing this task could enable the adoption of renewable desalination in developing economies and enable sustainable, decarbonized, low-OPEX desalination in large-scale industrial applications.

### SUMMARY OF THE INVENTION

In one aspect, in general, an electrodialysis system controller is configured to be coupled to (a) a power supply, and (b) powered devices that include (b1) a pump, and (b2) an electrodialysis unit. The controller receives inputs including (i) an input indicative of a flow rate through the electrodialysis unit, (ii) an input indicative of a concentration level of fluid in the electrodialysis unit, and (iii) an input indicative of a power differential (e.g., indicating a degree to which a power usage by the powered devices differs from available power of the power source), and provides outputs for controlling the powered devices, including (i) an output for causing a variable current level to be applied in the electrodialysis unit, and (ii) an output for causing a variable fluid flow rate through the electrodialysis unit. The controller is configured to match the power usage to the available power, for example, to keep the power differential as small (e.g., in magnitude, square magnitude, or a time filtered magnitude) as possible, while still achieving the optimal and maximum production rate for that given input power.

The system can be used for desalination in which the electrodialysis unit produces relatively desalinated water, for example, using a batch process in which diluent and concentrate are cycled through the electrodialysis unit producing progressively greater desalination of the diluent.

An advantage of matching the power usage to the available power is that total desalination rate (e.g., the total reduction in salinity of the output diluent) is increased (e.g., maximized) according to the available energy.

Aspects can include one or more of the following features.

The power supply comprises a power source and the electrodialysis system includes an energy buffer coupled to both the power source and the powered devices, such that the power source primarily provides energy directly to the powered devices. The energy buffer (storage) provides a safeguard of extra storage to be drawn from by the powered devices, or charged by the power source. The energy buffer can be a battery or a capacitor. This energy buffer is greatly reduced (compared to the state of the art) or eliminated by our control scheme.

The power source provides a time varying amount of power, and the powered devices consume a time varying amount of power, and the power differential represents a rate of change of stored energy in the energy buffer.

The power source comprises a photovoltaic array, which produced variable available power, for example, according to sunlight conditions. However, the power source could include but is not limited to wind, diesel generators, and intermittent grid tracking. The rate of desalination can be advantageously maximized according to the available power.

The output causing the variable current level comprises a signal representing a current level to apply to the electrodialysis unit.

The signal representing the current level is provided by the controller to a switching mode power converter coupled on a path between the power supply and the electrodialysis unit, which causes current at the provided current level to be passed to the electrodialysis unit.

The switching mode power convert converted comprises one or more of a boost converter, a buck converter, and a charge pump. For instance, the power converter comprises a boost-buck converter. Other types of power converters, such as a flyback converter, may be used.

The controller implements a first control loop that accepts the input indicative of a concentration level of fluid and an input indicative of the flow rate of this fluid in the electrodialysis unit and provides the determined current level to the power converter linked to the electrodialysis stack.

The controller determines the current level based on a maximum current level beyond which electrolysis would occur in the electrodialysis unit, for example, as a fraction (e.g., fixed fraction) of the maximum current level, often called limiting current in the literature.

The controller implements a second control loop that accepts the input indicative of a power differential and provides the output causing a variable fluid flow rate according to said accepted input.

The second controller is configured to reduce the magnitude of the power differential. For instance, the second controller implements a PID (proportional-integral-derivative) controller. However, other feedback control implementations can be implemented including simple on-off control, or other nonlinear methods including LQR.

The second controller is configured to mitigate (and ideally eliminate) transients in power usage in response to changes in the power differential.

The second control loop has a lower bandwidth and/or a longer sampling time than the first control loop. This follows typical recommendations for cascade-control.

An advantage of implementing the first control loop is that reduction is salinity, which may reduce the maximum current, can cause a rapid response of reduction in current level of the power converter. Another advantage in implementing the first control loop, is that this loop guarantees a maximum desalination rate for a given salinity and flow rate.

An advantage of controlling the powered devices according to the power differential may be that the total energy storage capacity of the energy buffer may be reduced, for example, enabling use of a smaller battery and/or replacement of a battery with a capacitor. For example, a well-tune second controller with appropriately sized and responsive actuators can eliminate the need for the energy buffer altogether.

The input to the controller indicative of the flow rate through the electrodialysis unit is provided by a flow rate sensor disposed on a fluid path coupling the pump and the electrodialysis unit.

The pump may have a DC motor, and a DC-DC power converter can control a voltage of the motor to vary the flow rate.

The pump can be powered by an induction motor, and the controller provides control signals for multiple phase inputs to the induction motor.

The photovoltaic array can be coupled to a DC-DC power converter for maintaining a maximum power point (MPP), and the controller can include an output for tracking the MPP (i.e., MPP tracking) and providing a controlled voltage to the energy buffer.

Other features and advantages of the invention are apparent from the following description, and from the claims.

### BRIEF DESCRIPTION OF THE DRAWINGS

FIG. 1 is a schematic diagram of a desalination system.

FIG. 2 is a schematic illustrations of mass balance on a diluate tank and an electrodialysis stack.

FIG. 3 is an illustration of a conceptual flowchart of coupled relationships in electrodialysis desalination.

FIG. 4 is a block diagram of a nested control system.

FIG. 5 is a schematic diagram of typical system power and information flows.

FIG. 6 is a graph illustrating typical power tracking behavior for a direct-drive system.

### DETAILED DESCRIPTION

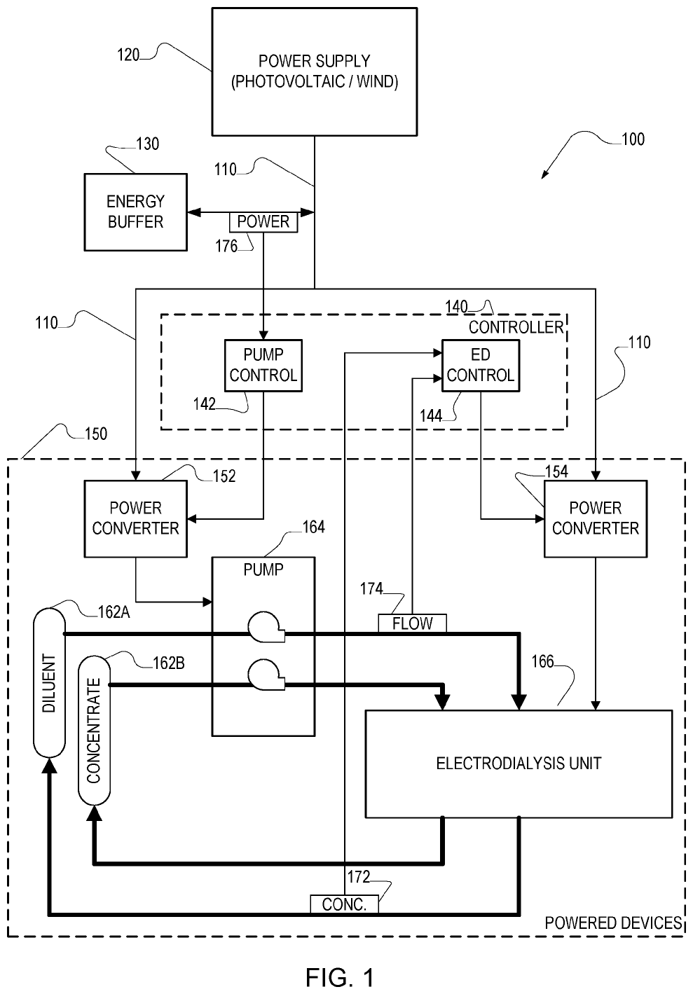

Referring to FIG. 1, a desalination system 100 includes a power supply 120, in this example a photovoltaics power supply and/or a wind turbine power supply, with the power supply optionally including electronics to maintain substantially constant output voltage. Power from the power supply flows over a power distribution network (“input supply rails”, “power bus”) 110 to powered devices 150, and in particular flows to a controlled power converter 152, which drives a pump (or pumps) 164 and another controlled power converter 154, which drives an electrodialysis unit 166. The pump 164 circulates fluid from tanks 162A-B, a diluent and a concentrate tank, respectively, through the electrodialysis unit 166, at a flow rate determined by a control input of the power converter 152. The electrodialysis unit 166 receives a current flow from the power converter 154, at a current level determined by a control input 144 to the power converter 154, thereby causing the salt concentration in the diluent to become progressively lower. Powered devices 150 may optionally include further devices not illustrated in FIG. 1, for instance computation, control, communication, or sensor devices.

An energy buffer 130 is coupled to the power distribution network, such that when the available power from the power supply 120 exceeds the power demand of the powered devices 150 power flows into the energy buffer (at least to the extent that there is available capacity), and conversely, when the power demand of the powered devices exceeds the available power from the power supply, power flows from the energy buffer 130 (at least to the extent that there is available energy). In this example, the energy buffer is made up of a battery. Alternatively, a capacitor bank with sufficient capacity may be used.

A controller 140 receives control inputs including from a power sensor 176, which provides the power flow rate (i.e., magnitude and direction) flowing in or out of the energy buffer, from a flow sensor 174, which measures the flow rate of the diluent through the electrodialysis unit (“stack”) 166, and from a concentration sensor 172, which measures the salt concentration in the diluent leaving the electrodialysis unit 166. This power sensor 176 could be manifested for instance as a current sensor or voltage sensor.

The controller includes an electrodialysis control unit (“current control”) 144, which uses the flow rate and the concentration to determine a target current level, in this example, as a fixed fraction of a model-based computation of the maximum current level beyond which electrolysis of the fluid would occur. The electrodialysis control unit 144 provides the target current level to the power converter 154 on a substantially continuous basis (i.e., either as a continuous signal or a rapidly sampled discrete time signal). The power converter 154 may be, for instance, a boost-buck converter or a flyback converter, and responds to the target control signal to maintain the current level provided to the electrodialysis unit at the target level.

The controller includes a pump control unit (“flow control”) 142, which uses the output of the power sensor 176 (i.e., the power differential) and provides a pump control signal to a power converter 152, which controls the driving signal (e.g., voltage) of the pump 164. This control signal generally does not represent a computed target flow rate. Rather, the driving signal is related to the flow rate, for example, a larger driving signal resulting in a larger flow rate (i.e., in a steady state). For example, the pump 164 includes a DC motor, and the power converter 152 adjusts its DC output voltage according to the pump control signal provided to the power converter 152 from the pump control unit 142 of the controller 140. The pump control unit 142 receives the sensed power level from the power sensor 176, and generally increases the power applied to the pump 164 (and therefore reduces the flow rate) if power is flowing into the energy buffer 130, and reduces the power applied to the pump if power is flowing out of the energy buffer 130. The pump control unit 142 controls the dynamics of the response of the driving signal (i.e., the pump voltage) to the sensed power, in this example, using a PID (proportional-integral-derivative) control law that is tuned, for example, to minimize the energy storage capacity of the energy buffer (e.g., so that it does not reach capacity and/or does not discharge completely).

In some examples, the tuning of the dynamics of the controller permits the energy buffer to be eliminated entirely, for example, driving the controller using a power differential signal determined using a signal representing the available power from the power supply and the power usage of the powered devices. In other examples, rather than controlling the voltage input, the control input can relate for example to a target current input to the pump motor.

The power converter 152 and 154 may be used in tandem to not only track power and maximize desalination rate, but to also draw the maximum power from the solar panels, acting as a maximum power point tracker (MPPT).

Note that while the electrodialysis unit 142 may respond quickly to a target current control input, the pump motor may experience a transient from when a control input (e.g., voltage) is increased or decreased and the power consumed by the pump (and therefore the entirety of the power usage of the powered devices) stabilizes because of factors such as mechanical inertial effects and/or speed-related motor aspects, such as reverse (back) electro-motive force related aspects. The pump control unit is tuned to reduce (and ideally eliminate) any transients in power usage by the pump in response to changes in the sensed power differential.

An embodiment of a system of the type discussed above with reference to FIG. 1 has an aim of using a direct-drive desalination controller to maximize the instantaneous water production rate, due to a lack of energy storage (i.e., a battery). In other words, this strategy utilizes all of the energy available at any given time (hence, direct-drive), and gives the proper allocation of energy to the subsystems that maximizes the desalination rate at that point in time.

An alternative embodiment of a system of the type discussed above with reference to FIG. 1 includes a desalination controller which tracks a desired power setpoint, such that an industrial scale plant may track dynamic grid pricing. In essence, the desalination system load is variable and dynamic at a frequency which may match or exceed variable grid power pricing.

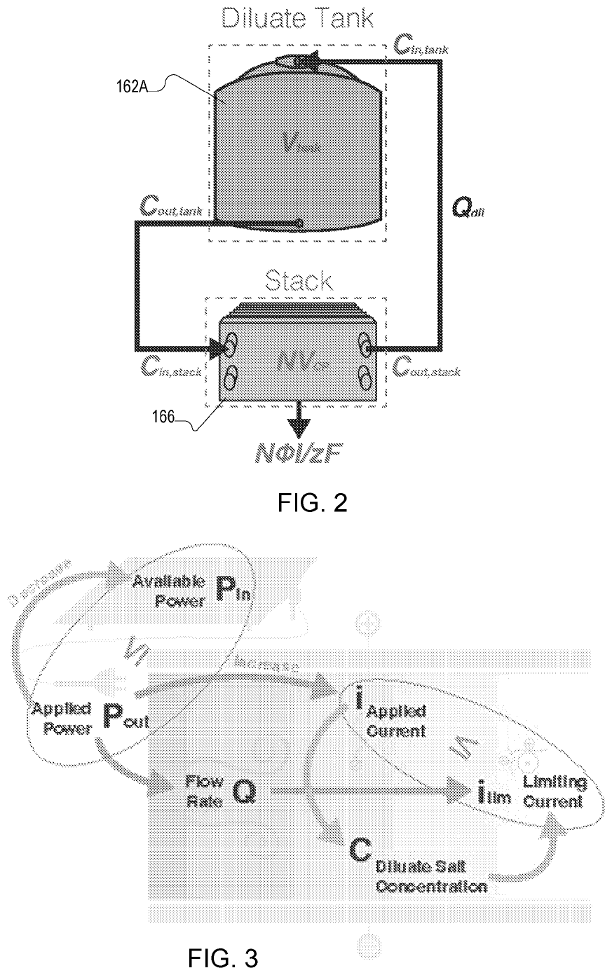

Desalination rate is characterized by the following equation derived from a mass balance with respect to the stack (see FIG. 2), where the first component describes the change in concentration of the stack over time, the second component describes the influence of flow rate (and can be related to the change in concentration of the tank), and the third describes the mass of charge transferred driven by current:

$${NV}_{CP} \frac{\partial {C}_{stack}}{\partial t} = {Q}_{dil} ( {C}_{in , stack} - {C}_{out , stack} ) - \frac{N ϕ I}{zF} .$$

In this equation, N is the number of cell pairs in the electrodialysis stack, V_{CP} is the volume of each cell pair,

$$\frac{\partial {C}_{stack}}{\partial t}$$

is the instantaneous change in concentration with respect to time (the desalination rate), Q_{dil} is the flow rate of the diluate stream, C_{in,stack} and C_{out,stack} are the concentrations into and out of the stack respectively, φ is the current leakage factor, I is the current through the stack, z is the ion charge number, and F is Faraday's constant. We neglect back diffusion in this description because it has been modeled and experimentally shown to have small and sometimes negligible effects on desalination rate and specific energy consumption, especially for high current densities and flow rates. Though too large of current densities can cause a significant concentration gradient across the membranes and begin to increase back diffusion. The proof applies regardless of the inclusion of back diffusion.

Note that we want

$$\frac{\partial {C}_{stack}}{\partial t}$$

to be maximally negative. We want C_{out,stack}<C_{in,stack} because we want a decrease in concentration over time in the diluate channels. The two parameters we have active control over are the flow rate and current of the system. Thus, to achieve a maximally negative first term, we must aim to minimize Q_{dil} while maximizing I. This can be intuitively understood as maximizing the flow of ions across membranes in the system (maximizing current) while keeping water within the system for the longest period or residence time (by minimizing flow rate). We can now see, to maximize the desalination rate within the electrodialysis stack, we must maximize current and minimize the flow rate. However, the maximum current applicable is non-linearly, positively related to the flow rate; in practice, there is a delicate balance between these two variables which produces the optimal desalination rate within the stack, which is discussed further in the next subsection.

In order to maximize desalination rate of a batch system (not just the stack itself), we must simultaneously balance the maximization of I and Q_{dil} (rather than minimize it). This can be easily seen when considering a mass balance of the diluate tank

$${V}_{tank} \frac{\partial {C}_{tank}}{\partial t} = {Q}_{dil} ( {C}_{in , tank} - {C}_{out , tank} ) .$$

Here, Vₜₐₙₖ is the volume of the diluate tank,

$$\frac{\partial {C}_{tank}}{\partial t}$$

is the desalination rate of the diluate tank, and C_{in,tank} and C_{out,tank} are the concentrations of water going into and out of the diluate tank, respectively.

Increasing the current on the stack will increase the concentration difference between the inlet and outlet of the stack (by decreasing C_{out,stack}), and thus also increase the concentration difference between the inlet and outlet of the tank C_{in,tank}−C_{out,tank}. Increasing the flow rate Q_{dil} will increase the rate at which this tank is experiencing desalination as salty water flows quicker out of the tank and fresh water flows quicker into the tank.

We aim to maximize current, however, the amount of current we are able to apply is constrained by two important factors: (i) available power and (ii) limiting current. Available power can be variable, especially with renewable energy sources such as solar or wind. Limiting current is the threshold at which water will begin to dissociate and begin to generate acids. It is, colloquially, the point at which water splits. One instance of an expanded equation for limiting current density is shown below, however, many models for limiting current exist:

$${i}_{lim} = \frac{{C}_{d} zF}{{t}^{AEM , CEM} - {t}_{+ , -}} \frac{{D}_{aq}}{{d}_{h}} * {α ( \frac{{ρ}_{aq}}{μ} \frac{Q}{ϵ whN} {d}_{h} )}^{β} {( \frac{μ}{{ρ}_{aq} {D}_{aq}} )}^{γ}$$

The terms α=0.29, β=0.5, γ=0.33 are empirically determined factors which influence the mass transfer coefficient, but have been shown to closely match the performance of many stack sizes and geometries (see, e.g., Natasha C Wright, et al. “A robust model of brackish water electrodialysis desalination with experimental comparison at different size scales.” Desalination, 443:27-43, 2018). Limiting current is a dynamic constraint that changes based on the water salinity, C_{d} and Q. If we are commanding limiting current (with some safety factor), we are maximizing the allowable current and thus desalination rate and water production rate.

The consumed and available power, flow rate, concentration, and limiting current are coupled levers and constraints. The coupled behavior can be observed in FIG. 3.

The two active levers we have control over are the flow rate and voltage applied to the desalination stack. More generally, we allocate power to the motor(s) which drive the pumps while also allocating power to the desalination stack electrodes. We can see within this conceptual flowchart, that as we increase flow rate, we also increase the limiting current and thus the amount of current we can apply to the system. However, as we increase current, we are increasing our desalination amount per pass through the stack and thus decreasing the salt concentration at the stack outlet. Decreasing this diluate salt concentration at the stack outlet in turn, decreases limiting current. Finally, when we apply increased flow and current, we also decrease the power available. The reader can observe the trade-off between the ideal amount of flow and current to apply is complex and not well characterized.

For a given power, we want to maximize the current density applied to the stack (maximizing our desalination rate) while applying sufficient flow rate to immediately use all of the available power. This strategy produces the maximum water production rate possible for a given amount of energy.

A real-time responsive approach is used to minimize computation time while quickly and consistently producing solutions that maximize water production rate of an electrodialysis desalination system. We can best understand this scheme by first thinking linearly in steps through each component:
1. If we have some surplus power, we can command some more flow via the motors and pumps. This flow rate will then positively influence limiting current (the maximum desalination limit).
2. We then can apply a current equal to limiting current with some safety factor.
3. The current and flow rate we command together consumes some of our available power.
4. If we continue to ramp up the flow rate, and thus ramp up the current which is positively coupled, we ramp up the power utilized until this matches the available power.
5. If we suddenly are using too much power, we can simply ramp down the flow rate, which decreases the limiting current and concurrently the actual applied current. This holistically decreases the power utilized.

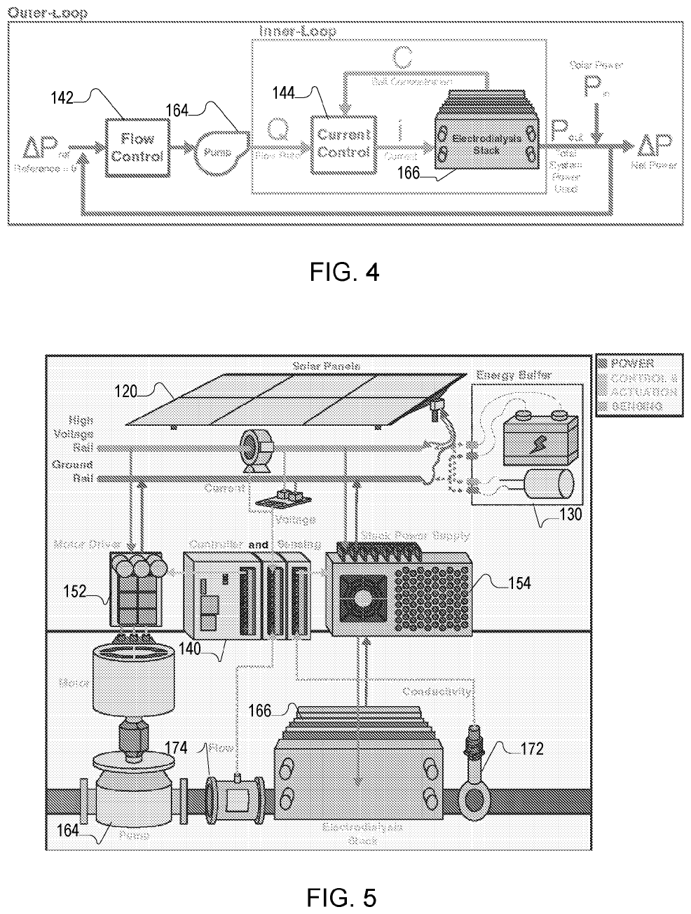

A main idea is that we always apply the maximum allowable current to maximize our desalination rate, while adjusting the flow rate around it to match the available power. To accomplish this concept, our application leverages a cascade control system with (i) an inner current control loop and (ii) an outer flow control loop controlled in our implementation by a PID controller (see FIG. 4). A cascade controller is a feedback controller that involves a nested loop where the inner control loop is reliant on what occurs in the outer control loop.

The inner loop involves current control on the desalination stack. We dictate that the current commanded to the stack is always some threshold (safety factor) of limiting current density.

$${I}_{cmd} = η ( {i}_{lim} A )$$

In this equation, η is a threshold safety factor, iₗᵢₘ is the limiting current density calculated from the diluate concentration and flow rate at the end of the stack, and A is the effective membrane area.

This inner loop calculation only has two dynamic variables. Thus, this concept relies solely on two sensor measurements: flow rate (e.g., from sensor 174) and diluate outlet conductivity (e.g., from sensor 172). All other parameters are static and defined by the desalination stack architecture. This current controlled approach is advantageous to voltage control, because the power supply will aim to provide the same current regardless of a variety of load conditions. Under current control, no calculation of the stack resistance is necessary. This is a key reduction in computational load as compared to prior approaches that focus on calculating voltage required to induce limiting current relies on models of stack resistance which can be complex, inaccurate, and may change over time as membranes and other components degrade.

Current control is accomplished by voltage or resistance regulation, which is a common practice in numerous power electronics architectures. For instance, linear-voltage regulators, transistors, operational amplifiers, and more are utilized for current control. Current control has many practical applications including controlling motor torque (as current and torque can be commonly modeled as linearly related in a motor).

We employ a PID controller where the process variable (to be tracked) is the net power consumed. Where net power is power supplied by solar irradiance subtracted from the power consumed by the motors for pumping, the EDR stack for desalination, and the latent hardware. Latent hardware includes lower power background operations such as the controller, sensors, cooling fans, etc.

We must aim to keep the net power consumed at a set point of zero, and can view variations in solar power as a variable disturbance on the net power, our process variable.

$${P}_{solar} - {P}_{motors} - {P}_{stack} - {P}_{latent} = Δ {P}_{net} = 0$$

The net power consumed can be tracked in a variety of ways:

First, the current in and out of a small energy buffer on the input supply rails is measured. This energy buffer may be a small battery, or could be a capacitor in parallel with the solar array. When the capacitor is charging, the system knows it is able to draw more power from the supply rail. When the capacitor is discharging, the system realizes it is drawing too much power from the supply rails. This scheme involves having a current reading set-point of zero on the energy buffer.

Second, the voltage of this power bus or rail is measured. This involves holding the capacitor or battery at a nominal voltage set-point (rather than using a net current of zero). The voltage set-point depends on the capacitor bank or battery configuration and nominal operating points. This configuration is also dependent on the power electronics requirements. For instance, the bus voltage must be within a range at which the power converters can operate. Practically, some batteries—such as lithium-ion phosphate—have relatively flat voltage versus percentage of charge curves; these are more difficult to use for voltage tracking because they would require higher sensor resolutions.

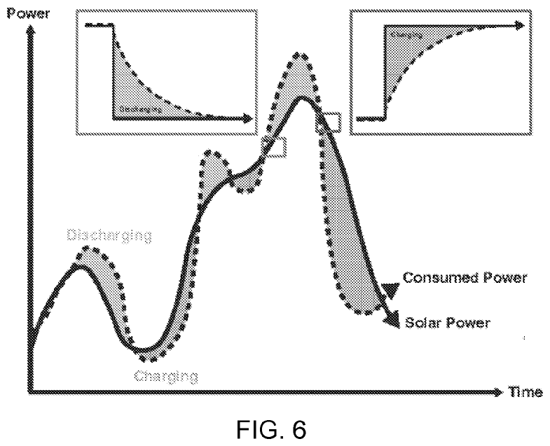

FIG. 5 shows the two aforementioned sensing methods (voltage and current) for tracking power and where those might be applied in practice. Either a battery or capacitor is shown to be connected to the high voltage and ground rail, and from these rails, power is drawn to subsystems including the pumps and stack. It also shows the control and two sensors for the inner control loop (flow and conductivity).

The output control effort is the motor speed which is connected to a pump, and thus to the flow rate into the stack. Recall, as we increase the flow rate to the stack, the motors and current controller will concurrently draw more power. As we decrease flow rate, the opposite occurs.

This approach is dependent on immediate sensing and responsive adjustment, rather than predictive computation with nested models. It additionally will readily guarantee solutions and avoids error propagation that may occur in nested model-based control—especially when the dynamics of the plant may change over time.

Closed-loop feedback control will inherently always produce solutions for flow rate and current. Implemented in the analog domain, this could be on the order of kilohertz or higher. In the digital domain, which is where the system is later implemented and a common realm for control, the rate of solutions produced is limited by the controller sampling frequency.

The current control calculation is fast—it involves one equation with basic algebraic operations. No iterative solvers such as root finding methods or computational loops are required. The reader may think of the PID controller on flow rate as an iterative method for continuously finding the optimal combination of flow rate and current for a given feed salinity and available power. The process variable we track (bus voltage or current) allows us to connect any number of latent power equipment such as controls, fans, etc., and the controller will still be able to readily adapt and operate.

Finally, the outer control loop can be readily translated to track power even in states when we are not desalinating. For instance, when we are filling or draining the tanks to prepare for a batch or are ending a batch, the inner current control loop will be disabled. However, the outer loop can still ramp up and down the pumping speed to fully utilize the available power.

It is important to note for cascade control to work, the inner loop disturbances should typically be less severe than the outer loop disturbances. In this case, the outlet conductivity disturbances or changes must be less severe than the disturbances in solar irradiance. This is true, as solar power and net power have variations that are much larger and faster than the changes in conductivity. It is additionally important to note that with nested control loops, the inner loop (current controller) must typically be sufficiently faster than the outer loop (the flow controller). Common values are at least three to four times as fast.

The inner-loop control strategy always produces the optimal desalination rate and minimizes specific energy consumption. However, the practical speed at which power is tracked depends on the outer loop design and tuning. Tuning PID loops has abundant literature. This work does not necessarily employ any new strategies for PID control or tuning; consequently, the flexibility within the outer loop controller in this proposed scheme may allow for greater adoption in practice. Any number of canonical tuning methods can be applied. However, it is important in any scheme to consider a few factors.

Firstly, the controller block which tracks power can be substituted with many different methods for linear control (proportional, PI, PD, PID) or nonlinear control (on/off). This work considers PID control with the aim of maximizing the response speed while minimizing overshoot; the PID loop should not cause significant overshoot of allocated power over available power because this may cause excessive current from the buffer (battery, capacitor).

Secondly, there is no one set of tuning parameters that are “perfect” in a PID system, only parameters that meet a designer's desired behavior or requirements.

Third, how one tunes the PID will affect the speed of the entire system response, and thus will in turn affect the required size of the energy buffer.

For any control systems, there are intertwined relationships between sensing speed and resolution, controller sampling frequency (especially relevant in discrete design) actuator capabilities and speed (i.e., How fast can these motors be moved and what is the maximum speed we can apply? How fast can we change current on the stack and what is the maximum current we can apply?). The most ideal control system would have the most accurate, highest resolution, and highest speed sensors. It would have a infinitely fast controller calculations and would have immediate actuator response with unlimited capability (e.g., an imaginary motor that could spin up to a very fast speed withstanding any amount of torque instantly). With real hardware, this is certainly not the case, and practical limitations on speed, resolution, and capability (control effort) will limit the power tracking and dynamics of the system.

In our application, we utilize PID control, which consists of three parameters to be tuned:
1. Proportional Gain—in our application, the weight of how much the net power differential affects our new pump speed.
2. Integral Gain—takes into account the time at which we have some error in power tracking and gains more and more influence over time.
3. Derivative Gain—this considers how quickly the error in our power mismatch is changing. Increasing this will tend to decrease any overshoots and create more stability; it can be thought of as a damper. However, it causes the system to be sensitive to noise and respond slower than desired.

Depending on practical hardware limitations as discussed earlier, (e.g., the speed of a flow rate response from the motors and pumps, the resolution of the current or voltage sensor) a small power buffer may be necessary with this strategy. In FIG. 6, if more power is utilized by the system than is available from the power source such as a solar array, an overdraw is observed and energy must be pulled from the energy storage device. If less power is utilized by the system than given from the solar array, this extra power is directed towards charging capacitors or batteries.

Common power electronics hardware often has some built in capacitance and energy storage. For instance, utilizing a larger solar array has some greater inherent capacitance lending it to less severe voltage fluctuations. Similarly, a larger motor driver will often have some more inherent capacitance to handle spikes in demand relative to a smaller driver.

Having faster control sampling rate (the rate at which we are able to observe the process variable) and actuation creates faster response to power fluctuations in a direct-drive system, and thus allows smaller and smaller energy storage devices to compensate for delays in response; as our pump size and controller speed and resolution are increased, the required battery decreases in size). Hence, for a given control speed and magnitude of capable control effort influenced by hardware limitations, we may explore the sizing requirement of this energy buffer.

A simple method for this desalination system uses a first order model of the power response, which is inherently derived from the slowest aspect of the plant—for PID tuning and energy buffer sizing.

This system which we are controlling is the plant, which when incorporated with our controller model can later incorporate solar irradiance profiles as input disturbances to predict behavior in practice. A first order plant model has some characteristic exponential growth or decay towards a final value, and is akin to the power dynamics observed from electrodialysis desalination.

Consider a step response of the system in a worst-case-scenario disturbance. This initial point occurs when the system is fully saturated with irradiance and can fully command its actuators to their maximum capabilities (i.e., if there was an infinitely large power source and all levers were turned all the way up—this is the maximum control effort). The response behavior is what would be experienced if the system was shifted immediately to zero irradiance, and thus, zero available power (metaphorically similar to throwing a blanket over the solar panels when they were just at the sunniest part of the day). This response behavior is influenced by the maximum the actuators can output (max. control effort), and by how quickly the controller can respond (control speed). This is the worst-case-scenario for the system, and the response from this scenario can aid in determining a safe approximation for the energy buffering required.

Note, how we tune the PID (or other control schemes) influences this control speed and thus, how well the control scheme responds to this power disturbance. A PID scheme that is tuned for rapid response may have large proportional gain and little derivative gain, leading it to a quick response and control speed—however, this quick response could cause overshoot in cases when solar power is increasing; the system may think it has more power than is available, and over-corrects by using too much power. Contrarily, increasing derivative gain could cause the system to respond too slowly to changes, even though it is more stable. There is a balance in which these parameters must be designed, and the final design of these parameters influences the control speed, and thus the energetic buffer required for operation.

In the worst case scenario discussed above the response has two design factors, (i) the maximum control effort and (ii) the control speed, which can be parameterized to determine the (iii) minimum viable energy storage requirement. The equations below describe a simple first-order system model for power and the calculation of energy

$${P ( t )}_{step , down} = {Ae}^{- t / τ}$$

$${P ( t )}_{step , up} = A ( 1 - {e}^{- t / τ} )$$

$$E = {\int }_{0}^{∞} P ( t ) dt$$

where A describes the initial and final state of the system, which is the maximum power draw the system is capable of producing, τ describes the time constant of the system response and can be related to the actuator speeds, control speed and tuning, and E is the energy required by the energy storage device to compensate for this overdraw.

We can quantify the maximum power draw (maximum control effort) based on the system hardware. This can be done via an analytical model by summating the maximum operating power from hardware specifications or other models for power of all system components when actuated to their maximum capability. This can also be accomplished via observation or experimentation by simply commanding 100% control effort from the control loop and observing the power consumed. This system identification methodology is more accurate to reality, but is disadvantageous in that it is designed a posteriori.

We can determine a final response speed by understanding the coupled behavior of the controller tuning and speed with the intrinsic plant speed. Alternatively, with an analytical model, using the motor capabilities and pump inertia, we can estimate the hydraulic plant time constant and utilizing the stack dynamics (measured or modeled) we can estimate the stack dynamics. These plants and a tuned controller can be holistically modeled to estimate the final system response speed. Again, the final response speed can also be found by using observation or system identification. 100% control effort can be commanded and the plant dynamics can be observed.

Once the maximum power draw and final response speed are modeled or empirically determined, we may integrate the system response to determine the energy overdraw, E, and thus the buffer needed to accommodate this system design.

However, regardless of plant and controller dynamics, the fastest controllable speed is dictated by the sampling frequency; a process can only be controlled at a speed that is less than or equal to half of the speed at which the process variable is sensed.

This energy overdraw, E, can be used as a design requirement for a capacitor bank or battery. Once the energetic requirement is understood, and the current spikes and nominal operating voltages are understood, then the approaches to sizing the energy buffer are well documented in literature. One example procedure is as follows.

In the case of a capacitor (or capacitor bank), some basic canonical steps are as follows.
1. Determine the worst-case-scenario energetic overdraw, E.
2. Determine the nominal operating voltage Vₙₒₘ and minimum viable voltage Vₘᵢₙ of the capacitor(s). This will vary based on the hardware requirements.
3. Solve for the capacitance required using C=2ΔE_{C}/(Vₙₒₘ²−Vₘᵢₙ²).
4. Consider the current spikes the system might experience for this worst-case-scenario power spike knowing the nominal operating voltage.
5. Incorporate the capacitance, operating voltage range, surge current and potentially the inrush current to determine the proper capacitor(s).

In the case of a battery, some basic canonical steps are as follows.
1. Again, determining the worst-case-scenario energetic overdraw, E will determine the minimum energy capacity of the battery.
2. The battery voltage will be sized from the power electronic requirements. For instance, a power supply or converter which intakes 48-60V will require the battery to be nominally between this range.
3. Again, consider the current spikes the system may experience at the nominal battery voltage and ensure the battery is capable of this discharge current.

A prototype of the approach described above was constructed and evaluated. The key components of this prototype consisted of:
1. Hydraulics
   a. SUEZ V20 prototype electrodialysis stack (2021)
   b. 85 gallon diluate tank
   c. 60 gallon concentrate tank
   d. 15 gallon electrode rinse tank
   e. 100 cell pairs
   f. 1¼ inch PVC (nominally)
   g. 1 inch reinforced hoses
2. Control and Sensing
   a. Koyo Click PLCs
   b. 3×ProSense Inductive Flow Meters (1×FMM50-1001, 2×FMM100-1002)
   c. 8×ProSense Pressure Transducers SPT25-20-0100A
   d. 4×Omega Conductivity Sensors (CDCE90000 Series)
   e. 5×Split Core Hall Effect DC Current Sensor CYHCT-C3TC
   f. Bus Voltage Transducer
   g. Victron SmartSolar MPPT
   h. 2×Renogy 48-Volt 50 Ah Smart Lithium Iron Phosphate Battery (2400 wh each)
   i. 3×DeWalt FLEXVOLT 20-Volt/60-Volt MAX Lithium-Ion 6.0 Ah (120 wh each)
3. Actuation
   a. 2×BLDC motors (NEMA 24 60 MM Brushless DC Motor)
   b. 2×BLDC drivers (EM-366 Brushless DC-Motor Driver 12-48V 30/25 A)
   c. 2×Centrifugal pumps
   d. 2 kW Stack Power Supply (100V, 20 A) consisting of (2×DPS5020 buck converters in series with 4×500 W Single Output DC-DC Converter Meanwell SD-500 for galvanic isolation)
   e. 20×Motorized DC Ball Valves (Tonhe A150-T32-P2-B)
4. Operation
   a. 300 L batch size
   b. hydraulic channel and electric polarity reversal triggered after 8000 Coulombs of charge saturation on capacitive carbon electrodes
   c. 6 panel solar array (1800 watt)

The controller was implemented using a Koyo Click Programmable Logic Controller which featured a built-in PID graphical user interface. The PLC handles real-time processing and timing, is able to manage the full desalination state machine, and includes the model-based inner current control loop through simple multiplication and division blocks. Data are communicated between the PLC and the sensors and actuators over 4-20 mA, 0-10V, RS232, RS485, and modbus TCP communication. Modbus TCP to MQTT is also utilized for time-stamped monitoring in InfluxDB and Node-RED data handling and dashboard interfaces.

A state machine was constructed for the prototype. The states are arranged in order of operation and occur with dependency on the prior state. For instance, state 2 cannot be entered without first entering state 1. State 1 leads to state 2, which leads to state 3, and so on until the final state which leads back to state 1. There are some exceptions, where error flags may be raised in case of a failure or safety hazard and the system may transition into a standby state from any of the aforementioned states. Additionally, there is an idle/standby state and low power state which does not follow this chronological dependency logic.

This state machine consisted of the following states.
Idle/Standby—power off to the system, controls on but state machine deactivated.
Error state—a state which trips the circuit breakers and disables power to all actuators. Can occur in instances such as overflows, under-filling, over-current or over-voltage, insufficient flow, and more.
Low Power—power is too low to run the system, but will automatically startup when sufficient power is reached.
1. Fill both tanks—both pumps are commanded and track power via PID to fill both diluate and brine tanks.
2. Fill diluate tank—the brine tank is less volume than the diluate tank for recovery greater than 50%. Consequently, the diluate tank must now be filled on its own, also via PID.
3. Even startup—a practical aspect, triggers the proper valve configuration and electrical polarity in preparation for batch operation and waits a small amount of time to confirm these tasks are done before beginning desalination.
4. Odd startup—the same as even startup, but with the reversal valve configuration.
5. Even desalinate—the FCCC control scheme is now operating, with the inner current control loop commanding current to the desalination stack and the outer PID loop tracking solar power.
6. Odd desalinate—the same as even desalinate, but with the reversal valve configuration.
7. Drain both tanks—after the target conductivity is reached in the diluate tank, both tanks are emptied to their proper outlets: product tank and drain.
8. Drain diluate tank—the diluate tank will often take longer to drain than the concentrate because it has more volume.

The prototype was heuristically tuned, initially using the classic Ziegler-Nichols method, but eventually was adjusted by feel by the operators and the derivative term was removed (the noise propagation of the derivative term made it track worse in practice; if stability is needed, perhaps a lead compensator rather than derivative term could be explored in future work). The process variable in the feedback loop was current into and out of a large battery pack. The control effort is applied to both of the motors as a percent of total power (0-100). Recall, the motors drive the pumps, flow rate, and eventually influence current to the stack and overall system power consumption. The integral included antiwindup limited by the control effort capabilities: (0-100%) of total motor power.

The tuning parameters used were:
1. Proportional Gain=10
2. Integral Gain=1
3. Derivative Gain=0

We initially included a large battery pack (4800 watt hours) to test the solar tracking over the period of an entire day at the Brackish Groundwater National Research Laboratory in Alamogordo, New Mexico. Then after analyzing the data, sized and proved the system functionality on a significantly smaller pack (120 watt hours).

Modifications and alternatives to the approaches described above may include the following.

Alternative methods of electrodialysis control (by controller 144) may directly control current and may use a switched inductor (e.g., boost, buck, or boost-buck converter, and potentially a switched capacitor network (charge pump).

The pump 164 is not necessarily driven by a DC motor. For example, the pump controller 142 may control a three-phase inverter (e.g., power converter 152) to directly control speed of the pump. Various types of of motors may be used, including brushless DC motors or induction motors.

The power supply 120 does not necessarily provide a fixed voltage. For example, the voltage may vary with wind-speed or with solar illumination. For solar systems, the power supply may include an integrated maximum power point tracker (MPPT) to optimize the power output of the solar array with varying illumination, and possibly resulting in varying output voltage if there is no integrated voltage control.

In some solar embodiments, the MPPT function is implemented via the power control for the electrodialysis stack and pump motors. For example, the current in the electrodialysis stack may be set as high as possible without exceeding the MPPT point, and then the MPPT is tracked by controlling the power consumption of the pump motor, for example, by controlling frequency for an induction motor. In such an embodiment, the energy buffer 130 is not necessarily needed, and the pump control can monitor the voltage and current from the photovoltaic array to maintain a maximum power point.

The controller may be implemented in software, hardware, or a combination of software and hardware. The software may include instructions stored on machine-readable media, such that when the instructions are executed by a processor, steps implementing the control units are performed. The controller may include hardware to implement some or all of the functions of the control units. Such hardware may include field programmable gate arrays (FPGAs), which are configured according to configuration data (e.g., “personality matrices”) that are stored on machine-readable media, and/or may include application-specific integrated circuits (ASICs), which may at least in part be fabricated according to instructions specified in hardware description language instructions stored on machine-readable media.

A number of embodiments of the invention have been described. Nevertheless, it is to be understood that the foregoing description is intended to illustrate and not to limit the scope of the invention, which is defined by the scope of the following claims. Accordingly, other embodiments are also within the scope of the following claims. For example, various modifications may be made without departing from the scope of the invention. Additionally, some of the steps described above may be order independent, and thus can be performed in an order different from that described.

1. An electrodialysis system controller configured to control an electrodialysis system that includes a power supply, and powered devices that include a pump, and an electrodialysis unit, the controller being configured to:
receive inputs including
an input indicative of a flow rate through the electrodialysis unit,
an input indicative of a concentration level of fluid in the electrodialysis unit, and
an input indicative of a power differential, and
provide outputs for controlling the powered devices, the outputs including
an output for causing a variable current level to be applied in the electrodialysis unit, and
an output for causing a variable fluid flow rate through the electrodialysis unit,
wherein the controller is configured to match power usage of the powered devices to available power from the power supply.

2. The controller of claim 1, wherein the output causing the variable current level comprises a signal representing a current level to apply to the electrodialysis unit.

3. The controller of claim 1, wherein the controller is configured to determine the current level based on the input indicative of a concentration level of fluid in the electrodialysis unit.

4. The controller of claim 3, wherein the controller is configured to determine the current level based on a maximum current level beyond which electrolysis would occur in the electrodialysis unit.

5. The controller of claim 1, wherein the controller is configured to implement a first control loop that accepts the input indicative of a concentration level of fluid in the electrodialysis unit and provides the determined current level.

6. The controller of claim 1, wherein the controller is configured to implement a second control loop that accepts the input indicative of a power differential and provides the output causing a variable fluid flow rate according to said accepted input.

7. The controller of claim 6, wherein the second control loop is configured to reduce the magnitude of the power differential.

8. The controller of claim 6, wherein the second control loop has a lower bandwidth and/or a longer sampling time than the first control loop.

9. The controller of claim 1, wherein the controller is configured to maximize available power from the power supply.

10. The controller of claim 9, wherein the power supply comprises a photovoltaic array, and the controller implements a maximum power point tracking (MPPT) for the array.

11. The controller of claim 1, wherein the input to the controller indicative of the flow rate through the electrodialysis unit is provided by a flow rate sensor disposed on a fluid path coupling the pump and the electrodialysis unit.

12. The controller of claim 1, wherein the signal representing the current level is provided by the controller to a switching mode power converter coupled on a path between the power supply and the electrodialysis unit for causing current at the provided current level to be passed to the electrodialysis unit.

13. (canceled)

14. An electrodialysis system comprising:
an electrodialysis unit;
a power supply;
powered devices including a pump for passing fluid through the electrodialysis unit;
a controller for controlling the electrodialysis unit and the pump, said controller configured to:
receive inputs including an input indicative of a flow rate through the electrodialysis unit, an input indicative of a concentration level of fluid in the electrodialysis unit, and an input indicative of a power differential, and
provide outputs for controlling the powered devices, the outputs including an output for causing a variable current level to be applied in the electrodialysis unit, and an output for causing a variable fluid flow rate through the electrodialysis unit,
wherein the controller is configured to match power usage of the powered devices to available power from the power supply; and
a power converter coupled on a path between the power supply and the electrodialysis unit for causing current at the provided current level to be passed to the electrodialysis unit.

15. The system of claim 14, wherein the power converted comprises a switching mode DC-DC converter.

16. The system of claim 15, wherein the switching mode DC-DC convert converted comprises one or more of a boost converter, a buck converter, and a charge pump.

17. (canceled)

18. The system of claim 14, wherein the pump comprises a DC motor, and the system further comprises a DC-DC power converter for controlling a voltage of the motor to vary the flow rate.

19. A machine-readable medium comprising instructions stored thereon, execution of said instructions by a processor causing control an electrodialysis system that includes a power supply, and powered devices that include a pump, and an electrodialysis unit, said instructions causing said system to:
receive inputs including
an input indicative of a flow rate through the electrodialysis unit,
an input indicative of a concentration level of fluid in the electrodialysis unit, and
an input indicative of a power differential, and
provide outputs for controlling the powered devices, the outputs including
an output for causing a variable current level to be applied in the electrodialysis unit, and
an output for causing a variable fluid flow rate through the electrodialysis unit,
wherein the controller is configured to match power usage of the powered devices to available power from the power supply.

20. The system of claim 13, further comprising a machine-readable medium comprising instructions stored thereon, execution of said instructions by a processor cause the controller to control the electrodialysis unit and the pump.
